(19) United States
(12) Patent Application Publication
(10) Pub. No.: US 2022/0253837 A1
(43) Pub. Date: Aug. 11, 2022

(54) SYSTEMS FOR HYBRID ACCOUNT INTERACTIONS AND METHODS OF USE THEREOF

(71) Applicant: JALS, LLC, Wilmington, DE (US)

(72) Inventors: Spencer Schneider, Miami, FL (US); Louie Eisen, New York, NY (US)

(21) Appl. No.: 17/581,430

(22) Filed: Jan. 21, 2022

Related U.S. Application Data
(60) Provisional application No. 63/147,932, filed on Feb. 10, 2021.

(51) Int. Cl. G06Q 20/38; G06Q 20/20; G06Q 20/06

(52) U.S. Cl. CPC G06Q 20/381; G06Q 20/06; G06Q 20/20

(57) ABSTRACT

Systems and methods of the present disclosure enable hybrid physical-digital activities using a processor of a platform to receive an electronic record recording at least one specified value and at least one physical item having at least one item value. A difference between the at least one specified value and the at least one item value is determined. A first profile associated with the first device is identified, and a token representing the first profile and at least one digitized item associated with the difference is generated. The token is transmitted to the first device. The token is then received from a second device. A second profile associated with the second device is determined, and the at least one digitized item is transferred from the first profile to the second profile based at least in part on the token.

### RELATED APPLICATION(S)

This application claims priority to and the benefit of U.S. Provisional Patent Application No. 63/147,932, filed Feb. 10, 2021, the contents of which is hereby incorporated by reference herein in its entirety.

### FIELD OF TECHNOLOGY

The present disclosure generally relates to computer-based platforms and systems configured for hybrid account interactions including multiple modes of interaction for any particular account-related activity.

### BACKGROUND OF TECHNOLOGY

Account-related interactions may include electronic recordation of physical activities, or electronic recordation or logging of electronic activities. Sometimes a physical activity can be more convenient initially but then become more cumbersome than an electronic activity as the activity progresses. However, in many types of account-related interactions, such as, e.g., electronic messaging, transfers of funds and payments, file transfers, and others, there is a need for a more convenient and efficient mechanism to initiate an account-related activity physically and later switch the account-related activity to an electronic form.

For example, spare change is an inconvenience for both consumers and merchants. Paying cash for goods can leave consumers with unwanted change to carry around throughout their day, often without a convenient place to store it. Most individuals either tell stores to keep the change for the sake of one's own convenience or choose to leave the change at home which goes unused and accumulates overtime without reusing the money in the economy.

When it comes to merchants, cash and spare change create multiple issues with respect to both time and money. Counting and dealing with change during a transaction is a timely process compared to electronic payments. This creates long lines and checkout times at retail locations. Behind the register, weekly cash, and rolled coin orders are necessary to give out to cash-paying consumers. With respect to money, a common form of loss in retail stores is through theft and mishandling of cash by employees.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 is a block diagram of a system for hybrid physical-electronic account interactions in accordance with one or more embodiments of the present disclosure.

FIG. 2 is a block diagram of another exemplary system for hybrid physical-electronic account interactions in accordance with one or more embodiments of the present disclosure.

FIG. 3 illustrates a flowchart of an illustrative methodology for hybrid physical-electronic account interactions in accordance with one or more embodiments of the present disclosure.

FIG. 4 illustrates a flowchart of an illustrative methodology for hybrid physical-electronic account interactions in accordance with one or more embodiments of the present disclosure.

FIG. 5 depicts a block diagram of an exemplary computer-based system and platform 500 for hybrid physical-electronic account interactions in accordance with one or more embodiments of the present disclosure.

FIG. 6 depicts a block diagram of another exemplary computer-based system and platform 600 for hybrid physical-electronic account interactions in accordance with one or more embodiments of the present disclosure.

FIG. 7 illustrates schematics of exemplary implementations of the cloud computing/architecture(s) in which the hybrid physical-electronic account interactions may be specifically configured to operate in accordance with one or more embodiments of the present disclosure.

FIG. 8 illustrates schematics of exemplary implementations of the cloud computing/architecture(s) in which the hybrid physical-electronic account interactions may be specifically configured to operate in accordance with one or more embodiments of the present disclosure.

FIG. 9 depicts an example GUI of an example software application on a computing device for executing transfers of digitized items in the hybrid mode platform through the use of a token including scanning a QR code and/or barcode in accordance with one or more embodiments of the present disclosure.

FIG. 10 depicts an example GUI of an example software application on a computing device for executing transfers of digitized items in the hybrid mode platform through the use of a token including presenting a QR code and/or barcode in accordance with one or more embodiments of the present disclosure.

FIG. 11A depicts an example GUI of an example software application on a computing device for executing transfers of digitized items in the hybrid mode platform through the use of a token including presenting a QR code and/or barcode in accordance with one or more embodiments of the present disclosure.

FIG. 11B depicts an example GUI of an example software application on a computing device for executing transfers of digitized items in the hybrid mode platform through the use of a token including presenting a QR code and/or barcode in accordance with one or more embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

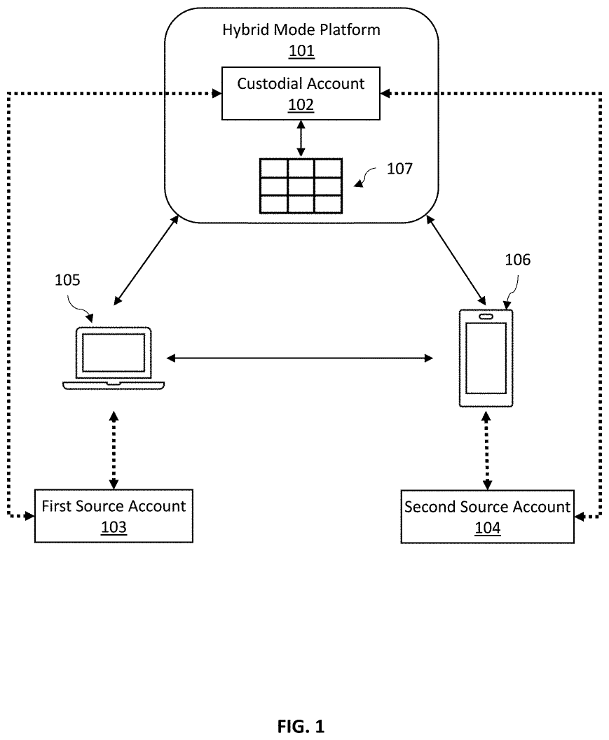

FIGS. 1 through 10 illustrate systems and methods of account-related activity execution that involves digitized physical items in response to physical item activities. In some embodiments, the systems and methods provide technical solutions and technical improvements that overcome technical problems, drawbacks, and/or deficiencies in the technical fields involving physical activities for account interactions. There is a need for a solution to efficiently digitize a physical return for a real-time transfer in response to a physical activity. For example, change in the form of physical currency that consumers receive in a cash transaction cannot be returned to the consumer digitally or electronically. Similarly, an electronic data file transferred physically cannot be efficiently responded to or confirmed electronically. While one solution may include an automatic round-up method of debit and credit card payments to savings and investing accounts, such methods only apply to electronic transactions and thus cannot be implemented in physical activities such as cash transactions.

As explained in more detail, below, technical solutions and technical improvements herein include aspects of improved activity recordation and execution that can implement hybrid physical-electronic activities for inter-account communications and other account interactions. For example, an account-related activity that is initiated physically may employ real-time digitization of physical items to effectuate an electronic response to the physical initiation, thus mixing physical item exchange with electronic data exchange to complete the account-related activities.

For example, for hybrid physical-electronic payments, from a consumer perspective, an individual can create an account on their device, such as smartphone, laptop computer, desktop computer, wearable device, etc. via a local software application, cloud-based software application, hybrid cloud software application, web browser or other software interface, thus creating an account that may act as a digitized item bank. This allows spare change to be given back digitally to consumers at the point of sale as a result of a physical currency paid transaction. The spare change (which may be held in a custodial account and accessed on a consumer's device) can be accumulated and reused at a point of sale. From a merchant perspective, the system provides a digital register integrated with a point-of-sale machine that allows stores to provide the digital change to consumers rather than physical change at the point of sale.

To enable a response of digitized items to a physical item, a new type of backend system must be created. Typically, platforms allow users to exchange items in a multitude of ways. However, there has not been a platform at the point of exchange that allows a user to return digitized items to other users in response to physical items. By creating a new system that can process an account-related interaction without the need to communicate with the associated accounts, associated processors and/or gateways, and account management systems (e.g., inquiring and/or acquiring banks).

Based on such technical features, further technical benefits become available to users and operators of these systems and methods. Moreover, various practical applications of the disclosed technology are also described, which provide further practical benefits to users and operators that are also new and useful improvements in the art.

FIG. 1 is a block diagram of a system for hybrid physical-electronic account interactions in accordance with one or more embodiments of the present disclosure.

In some embodiments, a hybrid mode platform 101 may include a custodial account 102 to effectuate electronic activities based on hybrid physical-electronic interactions. In some embodiments, the custodial account 102 may hold digitized items (e.g., funds, assets, etc.) which may be linked to user profiles with a ledger 107 for efficient exchange of digitized items. In some embodiments, users, such as a first user and a second user, may sign up for the hybrid mode platform 101 and create a profile in the hybrid mode platform 101 to enable the assignment or attribution of digitized items in the custodial account 102 to the first user and the second user. In some embodiments, a user may have an associated account and/or profile that records electronic activities that the user participates in using electronic activity data entries.

In some embodiments, the hybrid mode platform 101 may integrate and/or orchestrate services across environments including cloud, server, database, and edge devices (e.g., user computing devices such as mobile devices including smartphones and tablets and personal computing devices such as laptop computers and desktop computers, as well as wearable devices, smart home devices, and any other suitable edge devices). In some embodiments, the hybrid mode platform 101 provides a backend for integrating services that facilitate the transfer of one or more currencies and currency alternatives, such as, e.g., fiat currencies, crypto/blockchain-based currencies, proprietary or merchant-specific points, credits or tokens, digital assets (e.g., digitized financial instruments such as contracts, mortgages, stocks, exchange-traded funds, etc.) for redemption with the merchant.

In some embodiments, the hybrid mode platform 101 may employ edge-based software for managing distributed and/or local services on a user's device, such as a blockchain ledger, offline digitized item transfers, among other services. Alternatively, or in addition, the hybrid mode platform 101 may include cloud-, server- or otherwise remote-based software and services to manage, e.g., integration of external services (e.g., digital asset brokerages and trading platforms, custodial accounts 102 for one or more currencies and/or tokens and any combination thereof, etc.).

In some embodiments, the hybrid mode platform 101 may include a centralized implementation. Thus, the hybrid mode platform 101 may include one or more network accessible services hosted on one or more servers, including software services for managing the custodial account 102 and network access by enrolled edge devices (e.g., the first device 105, the second device 106, and/or any other devices). The enrolled edge devices may have a software application or server installed thereon that includes protocols for exchanging custodial account 102 data, such as a ledger 107 or recordation of assignments of digitized items. An example may include a suitable implementation of cloud-based services, e.g., Software-as-a-Service, Function-as-a-Service, Platform-as-a-Service, or other provision of software services and/or microservices.

In some embodiments, the hybrid mode platform 101 may include a distributed network across edge devices enrolled with the hybrid mode platform 101. The edge devices (e.g., the first device 105, the second device 106, and/or any other devices), may have a software application or server installed thereon that includes protocols for exchanging custodial account 102 data, such as the ledger 107 or recordation of assignments of digitized items. An example may include a blockchain ledger, however other distributed networks may be used for the distributed sharing of data.

In another example, the hybrid mode platform 101 may include application programming interfaces (APIs) for orchestrating services related to the storage, maintenance and transfer of digitized items remotely from the edge devices (e.g., via a cloud, server, database or other remote system). Accordingly, a request for a transfer may include a specification of the digitized item to be transferred. Based on the request, the hybrid mode platform 101 may call, via an associated API, a service for providing, receiving, transferring or performing other tasks related to the transfer of the specified digitized item.

In another example, the hybrid mode platform 101 may include a server-based or cloud-based service that includes a ledger or table representing digitized items in the custodial account 102. The hybrid mode platform 101 may itself manage the transfers and assignments of digitized items via the ledger or table remote from the edge devices. Thus, the edge devices may be equipped with software for communicating with the hybrid mode platform 101 for initiating digitized item transfers.

In some embodiments, any combination of the above described examples may be employed for the hybrid mode platform 101. Any other suitable arrangement may be employed instead of or in combination with the above examples such that the hybrid mode platform 101 may effectuate the transfer of digitized items between user profiles in response to a physical exchange or transfer of physical items.

In some embodiments, the hybrid mode platform 101 may include hardware components such as a processor, which may include local or remote processing components. In some embodiments, the processor may include any type of data processing capacity, such as a hardware logic circuit, for example an application specific integrated circuit (ASIC) and a programmable logic, or such as a computing device, for example, a microcomputer or microcontroller that include a programmable microprocessor. In some embodiments, the processor may include data-processing capacity provided by the microprocessor. In some embodiments, the microprocessor may include memory, processing, interface resources, controllers, and counters. In some embodiments, the microprocessor may also include one or more programs stored in memory.

Similarly, the hybrid mode platform 101 may include storage, such as local hard-drive, solid-state drive, flash drive, database or other local storage, or remote storage such as a server, mainframe, database or cloud provided storage solution. In some embodiments, the hybrid mode platform 101 may be a cloud or server implemented platform. Accordingly, the hybrid mode platform 101 may implement one or more databases as storage.

In some embodiments, the term “database” refers to an organized collection of data, stored, accessed or both electronically from a computer system. The database may include a database model formed by one or more formal design and modeling techniques. The database model may include, e.g., a navigational database, a hierarchical database, a network database, a graph database, an object database, a relational database, an object-relational database, an entity-relationship database, an enhanced entity-relationship database, a document database, an entity-attribute-value database, a star schema database, or any other suitable database model and combinations thereof. For example, the database may include database technology such as, e.g., a centralized or distributed database, cloud storage platform, decentralized system, server or server system, among other storage systems. In some embodiments, the database may, additionally or alternatively, include one or more data storage devices such as, e.g., a hard drive, solid-state drive, flash drive, or other suitable storage device. In some embodiments, the database may, additionally or alternatively, include one or more temporary storage devices such as, e.g., a random-access memory, cache, buffer, or other suitable memory device, or any other data storage solution and combinations thereof.

Depending on the database model, one or more database query languages may be employed to retrieve data from the database. Examples of database query languages may include: JSONiq, LDAP, Object Query Language (OQL), Object Constraint Language (OCL), PTXL, QUEL, SPARQL, SQL, XQuery, Cypher, DMX, FQL, Contextual Query Language (CQL), AQL, among other suitable database query languages.

The database may include one or more software, one or more hardware, or a combination of one or more software and one or more hardware components forming a database management system (DBMS) that interacts with users, applications, and the database itself to capture and analyze the data. The DBMS software additionally encompasses the core facilities provided to administer the database. The combination of the database, the DBMS and the associated applications may be referred to as a “database system”.

In some embodiments, the hybrid mode platform 101 may implement one or more computer engines for the various tasks and functions of implementing hybrid electronic-physical activities. In some embodiments, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some embodiments, an electronic activity data entry may include, e.g., a user identifier associated with each data entry, a third-party entity identifier associated with each data entry, an activity type identifier, an activity value or activity quantity, a time data item, a location data item, a date data item, a device type or device identifier associated with the electronic activity execution device, an activity description, or other attributes representing characteristics of each data entry.

For example, in some embodiments, the electronic activity data entry may include a transaction-related activity, such as a transaction record (e.g., transaction authorization request, posted transaction, a deposit, a withdrawal, etc.). In such an example, the data items may include, e.g., a transaction value, a transaction type, an account identifier or a user identifier or both, a merchant identifier, a transaction authorization date, a transaction post date, a transaction location, an execution device (e.g., point-of-sale device, Internet payment, etc.) among other transaction data and combinations thereof.

In some embodiments, one of the users, for example, the first user, may employ the first device 105 to execute electronic activities relative to a first source account 103 associated with the first user. Similarly, the second user may employ a second device 106 to execute electronic activities relative to a second source account 104 associated with the second user. Such electronic activities may include, e.g., electronically effectuated transactions between the first user and the second user, physical transactions between the first user and the second user that is recorded electronically (e.g., via the first device 105, the second device 106, or both), a combination of an electronically effectuated transaction and physical transaction, or other suitable electronic activities.

In some embodiments, an electronic activity may include a peer-to-peer (P2P) interaction between the first user and the second user. Thus, to execute the electronic activity relative to each of the first source account 103 and the second source account 104, the electronic activity would ordinarily need to be a two-way electronically effectuated activity, or a two-way physical activity recorded electronically. In face-to-face account interactions, the first user may employ the first device 105 to execute the electronic activity with the second user at the second device 106. In some embodiments, the electronic activity may include a recordation of an interaction including a physical item or items being passed from the second user to the first user whereby the first user executes the electronic activity relative to the first source account 103 via recordation at the first device 105.

In some embodiments, the execution of the electronic activity may include, e.g., the first user inputting or selecting physical item attributes associated with the physical item provided by the second user. For example, the physical item attributes may include, e.g., an item type, an item quantity, an item value, or other physical item attribute and combinations thereof. The first user may specify, e.g., via a graphical user interface (GUI), physical interface, or a combination thereof, the physical item at the first device 105.

In some embodiments, electronic activities may be executed automatically. A user may establish rules, triggers, or other parameters to execute electronic activities without the need to use the GUI or other interfaces for the electronic activity. In some embodiments, the parameters may be defined on the first device 105, on the second device 106, in a user profile with the hybrid mode platform 101, or any combination thereof. Based on the rules, without user interaction, an electronic activity may be executed to transfer, e.g., digitized items from the user's profile to another profile or designated account. In some embodiments, the transfer of physical items may necessitate the return to the second user of physical items of a different type or a different quantity or value of physical items. However, there are scenarios where the return of physical items to the second user is inconvenient or impractical, such as returning physical change for an overpayment. For example, a transaction in physical currency (e.g., cash) may require a two-way exchange of currency, such as a payment to the first user in one or more denominations, and a return of a remainder to the second user in one or more denominations. Alternatively, the second user may utilize electronic account authorizations, e.g., via a credit card or debit card, to electronically execute the transaction for an exact amount of money.

In some embodiments, the hybrid mode platform 101 may effectuate electronic activities where the transfer is of electronic items, such as digitized items attributed to a user's profile, and the return is a physical item of specified attributes (e.g., value, quantity, volume, size, shape, type, etc.). For example, a user may transfer a specified value of currency electronically to the second user, and the second user may return physical items including change or other denomination of currency according to, e.g., the first user's specified attributes.

Deployment of digitized items for exchange with other users would ordinarily require a communication with the other accounts of the other users. In such communication, the digitized items are ordinarily transferred electronically between accounts. Alternatively, the first user may exchange physical items in face-to-face interactions. However, there is a technological deficiency in conventional technology whereby when the first user engages in such exchanges, any return of items, whether digitized or physical, occurs via the same method (e.g., electronic communication or physical exchange). The ledger 107 and the custodial account 102 of the hybrid mode platform 101 present a technical improvement to the technology and/or technical field that enables a hybrid exchange, whereby an electronic communication of digitized items is responded to with a transfer of physical items, or a transfer of physical items is responded to with an electronic communication of digitized items,

In some embodiments, the custodial account 102 provides a middle layer between the first source account 103 and the second source account 104 to hold digitized items for dynamic transfer between the first user at the first device 105 and the second user at the second device 106. In some embodiments, the first user may link the first source account 103 to the custodial account 102 via a suitable account link, such as, e.g., an application programming interface (API), an automated clearing house (ACH), or other account communication technology and combinations thereof.

In some embodiments, the term “application programming interface” or “API” refers to a computing interface that defines interactions between multiple software intermediaries. An “application programming interface” or “API” defines the kinds of calls or requests that can be made, how to make the calls, the data formats that should be used, the conventions to follow, among other requirements and constraints. An “application programming interface” or “API” can be entirely custom, specific to a component, or designed based on an industry-standard to ensure interoperability to enable modular programming through information hiding, allowing users to use the interface independently of the implementation.

In some embodiments, the hybrid mode platform 101 may include a ledger 107 or other suitable record of digitized items associated with the users of the hybrid mode platform 101. In some embodiments, the digitized items and/or tokens, e.g., monetary funds, in the custodial account 102 may be accounted for in the ledger 107. In some embodiments, the custodial account 102 may include an aggregated account of digitized item for centrally managed or held digitized items, with the values and/or quantities of the digitized items assigned to particular users via the ledger 107. Accordingly, the first user may add digitized items to the first user profile in a custodial account 102 by transferring the digitized items from the first source account 103 to the custodial account 102 of the first user. The transfer may be affected by, e.g., a suitable API request or electronic transfer/communication. The digitized items may then be transferred into the aggregated account of the custodial account 102 and logged in the ledger 107 to ensure that the quantity and/or value of the digitized items is associated with the first user.

In some embodiments, the ledger 107 of the hybrid mode platform 101 may include, e.g., a look-up-table, array, index, relational database, or other data structure assigning digitized assets to particular users. In some embodiments, the ledger may include, e.g., a blockchain ledger, including one or more private and/or private-permissioned cryptographically-protected, distributed database such as, without limitation, a blockchain (distributed ledger technology), Ethereum (Ethereum Foundation, Zug, Switzerland), and/or other similar distributed data management technologies. For example, as utilized herein, the distributed database(s), such as distributed ledgers ensure the integrity of data by generating a chain of data blocks linked together by cryptographic hashes of the data records in the data blocks. For example, a cryptographic hash of at least a portion of data records within a first block, and, in some cases, combined with a portion of data records in previous blocks is used to generate the block address for a new digital identity block succeeding the first block. As an update to the data records stored in the one or more data blocks, a new data block is generated containing respective updated data records and linked to a preceding block with an address based upon a cryptographic hash of at least a portion of the data records in the preceding block. In other words, the linked blocks form a blockchain that inherently includes a traceable sequence of addresses that can be used to track the updates to the data records contained therein. The linked blocks (or blockchain) may be distributed among multiple network nodes within a computer network such that each node may maintain a copy of the blockchain. Malicious network nodes attempting to compromise the integrity of the database must recreate and redistribute the blockchain faster than the honest network nodes, which, in most cases, is computationally infeasible. In other words, data integrity is guaranteed by the virtue of multiple network nodes in a network having a copy of the same blockchain. In some embodiments, as utilized herein, a central trust authority for sensor data management may not be needed to vouch for the integrity of the distributed database hosted by multiple nodes in the network.

In some embodiments, the exemplary distributed blockchain-type ledger implementations of the present disclosure with associated devices may be configured to affect transactions involving Bitcoins and other cryptocurrencies into one another and also into (or between) so-called FIAT money or FIAT currency and vice versa.

In some embodiments, the exemplary distributed blockchain-type ledger implementations of the present disclosure with associated devices are configured to utilize smart contracts that are computer processes that facilitate, verify and/or enforce negotiation and/or performance of one or more particular activities among users/parties. For example, an exemplary smart contract may be configured to be partially or fully self-executing and/or self-enforcing. In some embodiments, the exemplary inventive asset-tokenized distributed blockchain-type ledger implementations of the present disclosure may utilize smart contract architecture that can be implemented by replicated asset registries and contract execution using cryptographic hash chains and Byzantine fault tolerant replication. For example, each node in a peer-to-peer network or blockchain distributed network may act as a title registry and escrow, thereby executing changes of ownership and implementing sets of predetermined rules that govern transactions on the network. For example, each node may also check the work of other nodes and in some cases, as noted above, function as miners or validators.

Similarly, in some embodiments, the second user, e.g., via the second device 106 may establish a recordation of digitized items in the custodial account 102 associated with the second user. The second user may also link a second source account 104 of the second user with the custodial account 102 to transfer digitized items between the second source account 104 and the custodial account 102. Thus, digitized items associated with the second user may be held in the aggregated account and assigned to the second user via the ledger 107 as with the first user as described above. As a result, specified values and/or quantities of digitized items may be moved between users in the custodial account 102 via ledger updates. Thus, the custodial account 102 can act as a proxy for the exchange of physical items without the need to perform multiple individual interactions and activities physically between users or electronically via the first source account 103 and the second source account 104 to balance a specified value or quantity of physical items.

In some embodiments, the custodial account 102 of the first user may employ the assigned quantity and/or value of digitized items to exchange in response to the receipt of physical items at the first device 105 to satisfy a specified quantity or value. In some embodiments, the first user may record the activity at the first device 105 including the receipt of the specified quantity or value of the physical items. The received specified quantity or value may be reported to the first source account 103, e.g., via a suitable API or other communication. However, in some embodiments, the first device 105 may also determine, e.g., based on the user selected physical item attributes and the specified quantity or value, that a return of a portion of the item quantity or the item value is to be returned to the second user. The first user may return physical items having a quantity or value equal to the portion or selected via the graphical user interface of the first device 105 to transfer digitized items representing the quantity or value of the portion via the hybrid mode platform 101.

In some embodiments, upon user selection to transfer the digitized items, the first device 105 may initiate a transfer by generating an API request to the hybrid mode platform 101 specifying the quantity or value of items associated with the portion. In some embodiments, in response to the API request, the hybrid mode platform 101 identifies the quantity or value of digitized items assigned to the second user in the custodial account 102 according to the ledger 107. Where the first user has sufficient quantity and/or value of digitized items, the hybrid mode platform 101 may authorize a transfer from the first user the digitized items of the specified quantity or value.

In some embodiments, to enable the transfer of the specified quantity or value, the hybrid mode platform may generate a token representing data for initiating the transfer of the specified quantity or value. In some embodiments, the token may include encoded data such as, e.g., user identifiers (e.g., a payer identifier, a recipient identifier, a merchant identifier, a customer identifier, etc.), a quantity and/or value associated with the transfer, a unique transfer identifier (e.g., a transaction identifier, operation identifier, message identifier, etc.), an action (e.g., give digitized items, return excess quantity or value, etc.), among other data or any combination thereof. The token may include any encoded data or indicia that may be passed between users in place of physical items. For example, the token may include, e.g., a quick reference (QR) code, a barcode, encoded data items (e.g., a cryptographic hash, a data link, an internet link, or other data item) or any other transferable data item transferable by wired or wireless means. For example, the encoded data items may include data transferable via, e.g., near-field communication (NFC), radio frequency identification (RFID) signals, Bluetooth, Bluetooth Low Energy (BLE), WiFi, ethernet, universal serial bus (USB), or any other wired or wireless means.

In some embodiments, the first user may transfer the quantity or value of items of the portion back to the second user via the token. For example, where a QR code is used, the first user may present, via the first device 105, the QR code on a display of the first device, to the second user. The second user may utilize the second device 106 to capture an image of the QR code to identify and receive the token. However, NFC, RFID, Bluetooth or other technologies may be implemented to communicate the token and data of the token to the second user.

In some embodiments, the token may include data such as, e.g., the quantity or value of items of the portion, an identifier identifying the first user, among other data. In some embodiments, the token may also include an identifier of the second user to ensure the transfer of the quantity or value is authenticated and executed for the actual intended recipient. However, in some embodiments, the token may omit the identifier of the second user such that the token may be transferred in place of physical items, without being tied to a given recipient, thus increasing simplicity and efficiency of the hybrid mode platform 101 by reducing the computational complexity of identify and authenticating the recipient.

In some embodiments, upon accepting the token, the second device 106 may send, e.g., via a suitable API request, a transfer request to transfer the quantity or value of items of the portion from the first user to the second user in the custodial account 102 via the ledger 107. For example, utilizing a suitable software application on the second device 106, the data of the token may be extracted from the token and communicated to the hybrid mode platform 101. The hybrid mode platform 101 may identify the first user based on the identifier specified in the token data and determine the quantity or value to be transferred based on the token data. The hybrid mode platform 101 may generate a ledger entry in the custodial account 102 transferring the assignment of digitized items of the quantity or value specified in the token data from the first user to the second, thus transferring the portion from the first user to the second user via digitized items in place of physical items.

In some embodiments, the two-sided system approach using the hybrid mode platform 101 utilizes, for both first user and second user, digitized items maintained by the hybrid mode platform 101 database. The hybrid mode platform 101 database will have profiles for each first user and second user that represents the value and/or quantity of digitized items assigned to the profiles. Accordingly, transferring digitized items between a first user and a second user may be implemented simply and efficiently as changes to the value and/or quantity of digitized items assigned to a first profile of the first user and a second profile of the second user in the hybrid mode platform 101 database.

The hybrid mode platform 101 provides a platform for the custodial account 102 that enables the custodial account 102 to hold all quantity or value of digitized items, of users under our hybrid mode platform 101 name. For example, the custodial account 102 holds the quantity and/or value of all users, and the hybrid mode platform 101 provides the functionality for user interactions via, e.g., the first device 105, the second device 106 and any other devices, to engage in electronic activities causing the transfer of digitized items between user profiles linked to the custodial account 102. No quantity or value of digitized items is removed from the custodial account 102 until a second user or first user executes a request to remove quantity or value of digitized items from their hybrid mode platform 101 database profile. No quantity or value of digitized items is added to the custodial account 102 until a second user or first user executes a request to upload a quantity or value of digitized items to their hybrid mode platform 101 database profile.

In some embodiments, to effectuate transfers of digitized items between users, based on the request from the first device 105, the hybrid mode platform 101 may identify the first user and/or the first device 105, e.g., including the profile associated with the first user and/or the first device 105. For example, the hybrid mode platform 101 may associate the profile with, e.g., a user name, a user profile identifier (e.g., an account number), a device identifier of the first device 105, or other identification mechanism. Similarly, the hybrid mode platform 101 may use an identification method to identify a profile in the custodial account 102 associated with the second user and/or the second device 106.

In some embodiments, for a hybrid electronic-physical interaction, the hybrid mode platform 101 may perform an onboarding process that includes an approval process to ensure that each user is legitimate. In some embodiments, the approval process may include, e.g., a validation of a governmental identification document, a financial account, a credit rating, phone number, email address, social media handle/name, etc. For example, in some embodiments, a user may be onboarded to the hybrid mode platform 101 to create a profile linked to the custodial account 102. The onboarding process may require the user to provide, e.g., a phone number (e.g., mobile phone number), email address, or other contact information. The hybrid mode platform 101 may verify the user by sending a challenge to the contact information, such as, e.g., a text message, an email, an internet chat, etc., with a one-time password, internet link with an expiration, or any other verification. Upon responding to the challenge, e.g., by providing the one-time password, selecting the internet link, or other response, the user may be validated as an authentic user, and the hybrid mode platform 101 may generate an associated profile for which digitized items in the custodial account 102 may be linked to attribute digitized items to the user. Therefore, each user, including the first user and the second user, as well as any number of additional users, may be on boarded onto the hybrid mode platform 101 to establish a respective profile in the custodial account 102 to which digitized items may be assigned.

In some embodiments, upon verifying the first user, the first device 105 may instruct the hybrid mode platform 101 to link the first source account 103 to the custodial account 102. In some embodiments, linking the first source account 103 to the custodial account 102 may include, e.g., validating account access by the custodial account 102 to the first source account 103 with, e.g., account credentials, an account identifier, a whitelisting of the custodial account 102, or other account access validation or permissioning technique. Similarly, in some embodiments, upon verifying the second user, the second device 106 may instruct the hybrid mode platform 101 to link the second source account 104 to the custodial account 102. In some embodiments, linking the second source account 104 to the custodial account 102 may include, e.g., validating account access by the custodial account 102 to the second source account 104 with, e.g., account credentials, an account identifier, a whitelisting of entities managing and/or hosting the second source account 104, a blacklisting of entities managing and/or hosting the second source account 104 or other account access validation or permissioning technique.

In some embodiments, upon onboarding the first user, the first user may specify, the first source account 103 (as described above) as well as profile parameters. In some embodiments, the profile parameters may set forth, e.g., transfer limits limiting a minimum and/or a maximum transfer of digitized items from the first source account 103 to the custodial account 102, a transfer frequency specifying a frequency at which the custodial account 102 is to request digitized items from the first source account 103 or submit digitized items to the first source account 103 to update the profile of the first user in the ledger 107, among other parameters. The first user parameters are a function that creates customizable boundaries for the first user's hybrid mode platform 101 database system profile. For example, in this feature, the first user can set high and low boundaries for auto-reloads and auto-withdrawals.

In some embodiments, to add digitized items to the profile in the database of the hybrid mode platform 101, the first user may execute a request (e.g., via an API), or parameters initiate an auto-request, to either transfer digitized items from the first source account 103 to the custodial account 102 to be assigned to the profile of the first user. Similarly, to remove digitized items from the profile in the database of the hybrid mode platform 101, the first user may execute a request (e.g., via an API), or parameters initiate an auto-request, to transfer digitized items from the custodial account 102 to the first source account 103. In some embodiments, a request to add or remove digitized items from the profile triggers the automatic transfer of digitized items, including transferring the digitized items to or from the custodial account 102 and updating the ledger 107 to reflect the transfer for the profile of the first user. For example, at an end of each day (or other specified time, e.g., each day, each week, each month, each quarter, each year or others and multiples thereof) if the balance is negative the first user initiates a transfer to custodial account 102 to balance the amount assigned to the first user in the ledger 107 to be equal to or greater than zero. If the first user profile is positive, the first user does not need to transfer digitized items to the custodial account 102, rather the first user may have the option to keep the positive balance for the next day or transfer part or all of that balance to the first source account 103. In some embodiments, the parameters may include auto-transfers between the custodial account 102 and the first source account 103 based on, e.g., a predetermined amount at a predetermined frequency, for example, every day, every week, every two weeks, every month, every two months, every three months, every five months, or combinations and multiples thereof. In some embodiments, the parameters may include auto-transfers between the custodial account 102 and the first source account 103 based on a sufficiency of an account balance to perform an exchange with another user. For example, where the first user attempts to transfer digitized items to the second user but has less balance than the amount of the transfer, the hybrid mode platform 101 may issue an insufficient balance alert to the first device 105 of the first user and, automatically according to the parameters, or upon command or a combination thereof, the hybrid mode platform 101 may initiate a transfer of a quantity from the first source account 103 to increase the balance of the first user profile.

Similarly, in some embodiments the second user may also establish parameters for the profile of the second user by selecting, e.g., via a suitable software application on the second device 106, parameters for transferring digitized items between the custodial account 102 and the second source account 104. For example, at an end of each day (or other specified time, e.g., each day, each week, each month, each quarter, each year or others and multiples thereof) if the balance is negative the second user initiates a transfer to custodial account 102 to balance the amount assigned to the second user in the ledger 107 to be equal to or greater than zero. If the second user profile is positive, the second user does not need to transfer digitized items to the custodial account 102, rather the second user may have the option to keep the positive balance for the next day or transfer part or all of that balance to the second source account 104. In some embodiments, the parameters may include auto-transfers between the custodial account 102 and the second source account 104 based on, e.g., a predetermined amount at a predetermined frequency, for example, every day, every week, every two weeks, every month, every two months, every three months, every five months, or combinations and multiples thereof. In some embodiments, the parameters may include auto-transfers between the custodial account 102 and the second source account 104 based on a sufficiency of an account balance to perform an exchange with another user. For example, where the second user attempts to transfer digitized items to the first user but has less balance than the amount of the transfer, the hybrid mode platform 101 may issue an insufficient balance alert to the second device 106 of the second user and, automatically according to the parameters, or upon command or a combination thereof, the hybrid mode platform 101 may initiate a transfer of a quantity from the second source account 104 to increase the balance of the second user profile.

In some embodiments, using the quantity or value of digitized items assigned by the custodial account 102 to the first user profile, physical exchanges as the first device 105 can be effectuated using the digitized items to supplement physical items. For example, the first user and the second user may perform an activity for electronic recordation. The first user may utilize the first device 105 to request to record the activity, including the physical item attributes involved. In some embodiments, the first user may select on the GUI of the first device 105 the physical item attributes and activity attributes, as described above.

For example, in a transaction for the purchase of products at a first user including a merchant. The merchant may select via the first device 105 (e.g., a point-of-sale device), the purchase details, such as the item to be purchased, the quantity, the value of the item, etc. The second user, including a customer may provide physical items, such as physical currency, to the merchant to effectuate the purchase, which the merchant may input into the first device 105 along with the purchase details.

In some embodiments, the first device 105 may compare the physical item attributes to the activity attributes, such as, e.g., an activity value compared with a physical item value, an activity quantity compared with a physical item quantity, among other attributes. For example, the value of the item and the quantity of the item to be purchased may be compared to the physical currency provided by the second user. Accordingly, based on a difference between the physical item attributes and the activity attributes, the first device 105 may automatically determine other physical items are to be returned to the second user, such as, e.g., physical items corresponding to a difference between the physical item value and the activity value. As a result, the first device 105 may automatically or according to user selection, issue a request to the hybrid mode platform 101 to return digitized items in place of the physical items, such as the return of a digital representation of currency value to return an excess of the physical currency over the value and quantity of the item to be purchased, e.g., the change for the transaction.

In some embodiments, in response to the request from the first device, the hybrid mode platform 101 may utilize the ledger 107 to reassign a quantity or value of digitized items from the profile of the first user to the profile of the second user, thus transferring a digital representation of the physical items to be returned to the second user. The hybrid mode platform 101 may then initiate a transfer of a value or quantity of digitized items corresponding to the difference described above, where the transfer reassigns the value or quantity of the digitized items to the profile of the second user, thus transferring the digitized items in place of the physical items owed to the second user.

In some embodiments, the transfer may occur automatically in response to a specification by the first user, specification including the intended recipient including the second user. The first user may input into the first device 105 a request for a digitized item return in place of a physical item return to the second user. Such a request may be communicated to the hybrid mode platform 101 to trigger the transfer of the digitized items to the profile of the specified recipient including the second user. In some embodiments, the hybrid mode platform 101 may identify a profile of the second user based on the specification of the intended recipient in the request. The hybrid mode platform 101 may then automatically reassign the digitized items from the profile of the first user to the profile of the second user. In some embodiments, the hybrid mode platform 101 may provide a notification (e.g., via text message, email, internet chat, application push notification, etc.) to the first device 105 and/or the second device 106 as notification of the transfer.

In some embodiments, alternatively or in addition, upon identifying the profile of the second user based on the intended recipient specified in the request form the first device 105, the hybrid mode platform 101 may identify a device associated with the second user, e.g., the second device 106. For example, the profile of the second user may specify contact information, a device identifier, or other identification mechanism, and send a communication, e.g., via text message, email, internet chat, push notification via a software application, or other technique to provide the token to the second device 106 rather than the first device 105. In some embodiments, the first device 105 may be used to confirm the token at the second device 106 and issue an authentication to the hybrid mode platform 101 to initiate the transfer.

In some embodiments, instead, as described above, the hybrid mode platform 101 may return to the first device 105 the token representative of the value or quantity of digitized items. The token serves as a transferable representation of the digitized items to be returned to the second user. Thus, the first device 105 may communicate the token to the second device 106 (e.g., wirelessly, via wired connection, optically, or by any other suitable means) and the second device 106 may utilize the token to claim the digitized items, thus triggering the transfer in the custodial account 102 of the digitized items into the profile of the second user. In some embodiments, to facilitate triggering the transfer, the token may include, e.g., a link or other token data to claim the value or quantity of the digitized items for a profile associated with the second device 106, e.g., the profile of the second user.

In some embodiments, the first device 105 may instead generate the token locally based on the physical items to be returned to the second user. For example, the first device 105 may generate a token that represents data including the quantity and/or value of the physical items to be returned, an identifier that identifies the profile of the first user (e.g., account number, device identifier, username, etc.). The first device 105 may communicate the token to the second device 106 (e.g., wirelessly, via wired connection, optically, or by any other suitable means) and the second device 106 may utilize the token to claim digitized items in place of the physical items. Thus, the second device 106 may issue a request to the hybrid mode platform 101 including the data from the token and/or the token itself to trigger the transfer in the custodial account 102 of the digitized items into the profile of the second user.

An illustrative embodiment can include the use of the hybrid mode platform 101 for returning digitized change in return for cash payments or other physical assets at a first user including a merchant. The merchant may have a profile in the custodial account 102 that has been attributed to it via the ledger funds loaded from the first source account 103 including a financial banking or credit account. In such an example, the custodial account 102 may provide access to distributable funds that the merchant can deposit into the custodial account 102 from the first source account 103 via a suitable monetary transfer technology, such as, e.g., automated clearing house (ACH), wire, credit, debit, Real Time Payments (RTP), among others or any combination thereof. Upon transferring the funds, the custodial account 102 may credit the funds to the merchant's profile. Deposits can be scheduled for, e.g., daily or weekly settlements of debits to the merchant's profile, or by any other suitable settlement period.

In such an illustration, the merchant's profile in the custodial account 102 may be used to distribute digital change to return change of excess payment in cash payments in real-time at the first device 105, including a point-of-sale device (e.g., cash register, payment processing computing device, or other point-of-sale device). In some embodiments, the digital change may be in the form of any suitable non-monetary and/or non-currency based signifier of value, including any suitable redeemable point or value system. For example, the digital change may include, e.g., merchant-specific rewards points serving as a proxy for monetary value at the merchant, or in the form of digitized currency (e.g., electronic funds, cryptocurrency, or other form of currency). In another example, the digital change may include, e.g., one or more industry- and/or merchant- and/or product-specific coupon redeemable for monetary value or for a decrease in a monetary value required for purchase. In some embodiments, the redeemable point or value system may include, e.g., digital currency, cryptocurrency, non-fungible tokens (NFT), or any other suitable redeemable value system.

In some embodiments, the term “point-of-sale”, “PoS” and/or “point of sale” refers to any suitable tool or combination of tools, including hardware and/or software, for executing an exchange of items and/or services for value, such as, e.g., goods or services for payment. Such tools may include hardware, such as, e.g., a smartphone, tablet, laptop computer, desktop computer, bank card reader, NFC reader, RFID reader, cash register, digital register, or any other suitable PoS hardware or any combination thereof. Such tools may include software, such as, e.g., software applications, programs, applets, plug-ins, extensions, encoder-decoders (“codec”), among other PoS software or any suitable combination thereof

In such an illustration, the merchant may employ the first device 105 including the point-of-sale device to user funds in the custodial account 102 to supplement cash and electronic payments at the first device 105. In some embodiments, the first device 105, upon merchant selection via a suitable software application, may instruct or request the hybrid mode platform 101 to credit or debit funds to profiles in the custodial account 102 to perform functions such as, e.g., provide digital change for cash payments (B2C), accept Payment at Point of Sale from a user's profile in the custodial account 102, transfer funds between the merchant's profile and a consumer's profile, transfer funds between two different merchant's profiles in the custodial account 102 (B2B), transfer funds between merchant sub-profiles (B2B), transfer funds between the merchant's profile in the custodial account 102 and linked bank accounts including the first source account 103, receive funds to upload to a consumer's profile in the custodial account 102 (e.g., to deposit a consumer's cash into the consumer's profile using the first device 105), withdraw funds from the consumer's profile and give cash to a consumer (e.g., to withdraw funds from the consumer's profile), accept ecommerce payments, among other functions leveraging via the first device 105 the profile in the custodial account 102.

In such an illustration, a user such as a consumer may engage in a face-to-face transaction with the merchant at the first device 105 including the point-of-sale device. The consumer may pay, e.g., in cash, check, vouchers, coupons or other monetary means and/or physical financial instrument to the merchant and the merchant may enter the cash amount and the value of the items or services purchased into the first device 105. The first device 105 may determine a difference between the cash amount and the value of the purchase and send a request to the hybrid mode platform 101 to settle the difference via the custodial account 102. For example, the consumer may pay in cash with an amount exceeding the value of the purchase. The first device 105 may send the request including the difference as an amount to be debited from the merchant's profile in the custodial account 102 and credited to a user profile in the custodial account 102 via the ledger 107. Accordingly, the hybrid mode platform 101 may generate a token for communication via a communication protocol, such as a QR code, NFC/RFID, Bluetooth, BLE, HTTP, or any other suitable communication protocol, to represent the amount to be debited from the merchant's profile and an identifier identifying the merchant's profile. The token may act as a transferable token that includes data for use by a recipient user (e.g., the consumer) to trigger the debit to the merchant's profile and a credit in the same amount to the recipient's profile.

In such an illustration, the hybrid mode platform 101 may return to the first device 105 the token for transfer to the second device 106, such as a machine-readable indicia (e.g., a barcode or QR code or other machine-readable indicia or any combination thereof) displayed on a display via a suitable software application on the first device 105, printed on a physical receipt, or other technique to present the machine-readable indicia, or as a data object, data file, or other data structure transferred by a wired or wireless connection, such as NFC, RFID, WiFi, Bluetooth, Ethernet, USB, etc. The second device 106 (e.g., a smartphone, tablet, wearable device, digital imaging device, laptop computer, or other computing device and/or mobile computing device) associated with the consumer may receive the token upon presentation and extract the data from the token. The second device 106 may upload the data in a request with an identifier identifying the consumer's profile in the custodial account 102 to the hybrid mode platform 101. The request may serve as authentication with the hybrid mode platform 101 to transfer funds from the merchant's profile to the consumer's profile in the custodial account 102. As a result, the hybrid mode platform 101 may create an entry in the ledger 107 debiting from the merchant's profile the amount of the difference and crediting the amount to the consumer's profile. While this illustration uses a payment in excess of the value of the purchase, the payment may also be deficient relative to the value of the purchase, such as the request from the first device 105 causes the hybrid mode platform 101 to create a token that, upon receipt and upload by the second device 106, cause the hybrid mode platform 101 to debit the difference from the consumer's profile and credit the difference to the merchant's profile, thereby supplementing the value of the cash payment to equal the value of the purchase. Thus, monetary change can be exchanged in either direction to mix physical currency and digitized funds to complete a payment in a face-to-face transaction.

In this illustration and others, the hybrid mode platform 101 enables a first user including a consumer to, e.g., collect change for cash payments in electronic funds, pay at a point of sale using a balance in the consumer's profile in the custodial account 102, transfer funds between consumer profile balance and merchant profile, transfer funds from their profile balance to another user's profile, transfer funds between the custodial account 102 and a linked bank account (e.g., the second source account 104, e.g., via an ACH request), give funds to merchant to upload to consumer account, receive cash by transferring funds to the merchant's profile in the custodial account 102 to receive cash from the merchant, withdraw and deposit funds into the consumer's profile in the custodial account 102 at a first device 105 including an automated teller machine (ATM), purchase goods online with profile information in the custodial account 102, among other hybrid electronic-physical payment transactions.

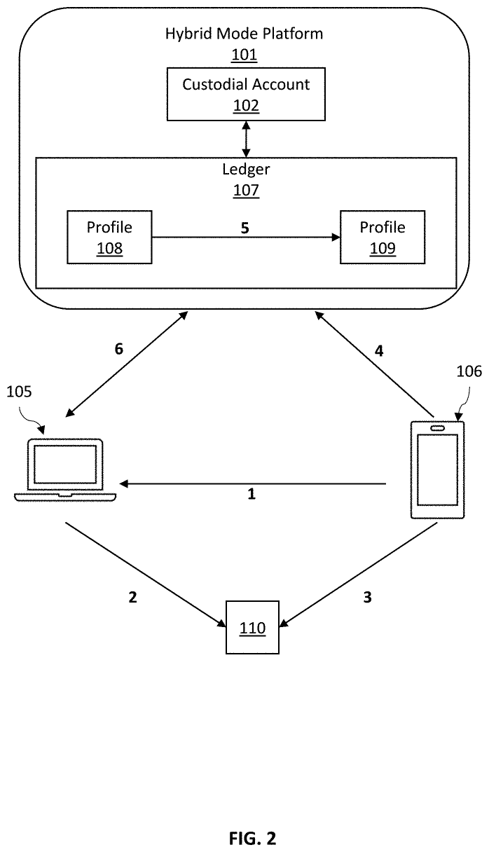

FIG. 2 is a block diagram of another exemplary system for hybrid physical-electronic account interactions in accordance with one or more embodiments of the present disclosure.

In some embodiments, step 1 may include a second user providing physical items for electronic recordation by the first device 105. In some embodiments, the electronic recordation may include a specification of the physical items provided, as well as a request for additional physical items or a same or different type to the physical items to be returned to the second user.

In some embodiments, upon the first device 105 generating the electronic recordation, the first device 105 may present at step 2 to a second device associated with the second user a token 110. In some embodiments, to initiate the transfer, the first device 105 may generate the token 110 signifying the digitized items to be transferred as well as an identifier of a profile associated with the first user from which digitized items are to be transferred from.

In some embodiments, the token 110 generated on the first device 105 can be receive (e.g., by optical scanning or wired or wireless data transfer) by the second device 106 at step 3. For example, in some embodiments, the token 110 may include a machine-readable indicia such as a barcode or QR code that may be communicated using optical scanning to initiate the transfer. In another example, the token 110 may employ non-visual indicia to encode the data and the non-visual indicia may be communicated via any suitable communication protocol to transfer data regarding the digitized items to be transferred, such as, e.g., NFC/RFID, Bluetooth, etc. In some embodiments, the token 110 may include, e.g., an identifier or profile identifier for the first user and the value or quantity of digitized items to be transferred. In some embodiments, the second device 106 may display a second user identifier. However, any suitable communication directly between the first device 105 and the second device 106 may be implemented in either direction (e.g., from the first device 105 to the second device 106, or from the second device 106 to the first device 105). In some embodiments, the first device 105 may produce a physical printing or other physical method of communication of the token 110, such as, e.g., a printed receipt, card or fob having an RFID chip, or other physical means.

In some embodiments, upon scanning the token 110, the second device 106 may instruct, at step 4, the hybrid mode platform 101 to initiate a transfer of the digitized items in the quantity or value specified from the first user's profile to the second user's profile in the custodial account 102. As a result, asynchronous and hybrid electronic-physical interactions are enabled to complete the in-person or face-to-face activity. Accordingly, in some embodiments, the second user has the ability to complete the exchange after leaving the first device 105.

In some embodiments, upon receiving the instruction to initiate the transfer according to the encoded data of the token 110, the hybrid mode platform 101 may update the custodial account 102 at step 5 to debit the value or quantity of digitized items from a profile 108 associated with the first user and credit the value or quantity of digitized items to a profile 109 associated with the second user. As a result, the first user's profile 108 with the custodial account 102 is decreased by the value or quantity of the digitized items and the second user's profile 109 with the custodial account 102 is increased based on the value or quantity of the digitized items received from the first user.

In some embodiments, the profile of the first device 105 may communicate at step 6 with the hybrid mode platform 101. In some embodiments, the communication between the hybrid mode platform 101 and the first device 105 may be initiated by the first device 105 upon the generation of the token 110, or may be initiated by the hybrid mode platform 101 upon receiving the instruction at step 4 or upon causing the transfer at step 5. In some embodiments, the communication may include a trigger for the hybrid mode platform 101 to check profile parameters for the first user's profile 108. In some embodiments, the profile parameters may establish rules for triggering automated reloads of digitized items into the profile of the first user according to conditions. In some embodiments, the profile parameters may trigger the hybrid mode platform 101 to add a value or quantity of digitized items to the profile of the first user from a linked account (e.g., the first source account 103) based on, e.g., rules regarding the total amount of digitized items in the profile, based on a time or frequency of reloads, or any other suitable parameters.

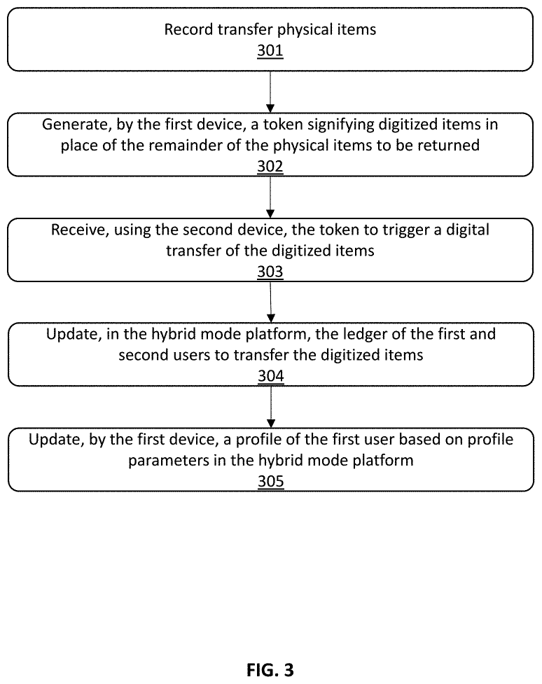

FIG. 3 illustrates a flowchart of an illustrative methodology in accordance with one or more embodiments of the present disclosure.

In some embodiments, at block 301, a first device may electronically record a physical transfer of physical items from a second user. In some embodiments, the electronic recordation may include a specification of the physical items provided, as well as a request for additional physical items or a same or different type to the physical items to be returned to the second user.

In some embodiments, upon the first device generating the electronic recordation, the first device may generate at block 302 a token signifying digitized items to be returned to the second user in place of a remainder of the physical items to be returned. For example, the token may include, e.g., a QR code, a bar code, encoded data transferred via, e.g., Bluetooth, NFC, RFID, WiFi, etc. In some embodiments, the token may include data items specifying, e.g., the digitized items to be transferred as well as an identifier of a profile associated with the first user from which digitized items are to be transferred from.

In some embodiments, the token may be received at block 303 by a second device to trigger a digital transfer of the digitized items representing the remainder to be returned to the second user. In some embodiments, upon receiving the token, the second device may cause a hybrid mode platform to initiate a transfer of the digitized items in a custodial account in the quantity or value specified from a profile of the first user identified in the token to the profile of the second user according to, e.g., a device ID or user ID of the second device. As a result, asynchronous and hybrid electronic-physical interactions are enabled to complete the in-person or face-to-face activity.

Therefore, in some embodiments, upon receiving the token, the hybrid mode platform, at block 304 may update a ledger of the custodial account to transfer the assignment of the digitized items representing the remainder from the profile of the first user to the profile of the second user. In some embodiments, the ledger may include, e.g., a table, a relational data structure, a blockchain, or other suitable ledger technology.

In some embodiments, the profile of the first device may communicate the transaction to the hybrid mode platform. In some embodiments, in response, the first device may update, at block 305, the profile of the first user based on profile parameters defined in the hybrid mode platform. In some embodiments, the profile parameters may establish rules for triggering automated reloads of digitized items into the profile of the first user according to conditions. In some embodiments, the profile parameters may trigger the hybrid mode platform 101 to add a value or quantity of digitized items to the profile of the first user from a linked account (e.g., the first source account 103) based on, e.g., rules regarding the total amount of digitized items in the profile, based on a time or frequency of reloads, or any other suitable parameters.

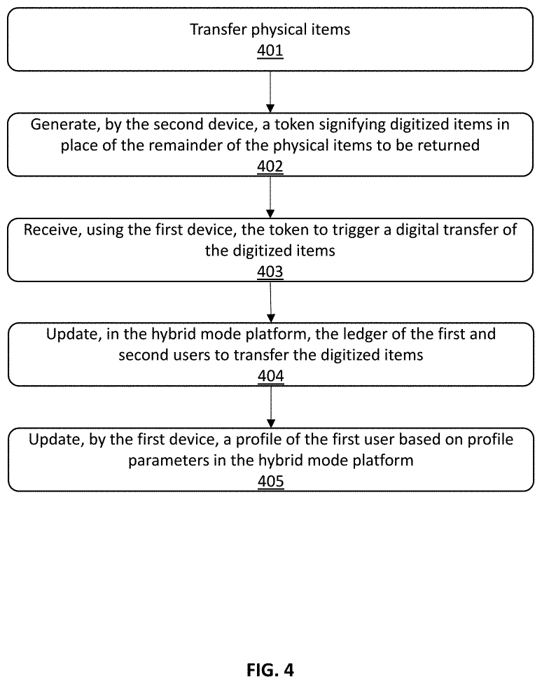

FIG. 4 illustrates a flowchart of an illustrative methodology in accordance with one or more embodiments of the present disclosure.

In some embodiments, at block 401, a first device may electronically record a physical transfer of physical items from a second user. In some embodiments, the electronic recordation may include a specification of the physical items provided, as well as a request for additional physical items or a same or different type to the physical items to be returned to the second user.

In some embodiments, upon the first device generating the electronic recordation, the second device may generate at block 402 a token signifying digitized items to be returned to the second user in place of a remainder of the physical items to be returned. For example, the token may include, e.g., a QR code, a bar code, encoded data transferred via, e.g., Bluetooth, NFC, RFID, WiFi, etc. In some embodiments, the token may include data items specifying, e.g., the digitized items to be transferred as well as an identifier of a profile associated with the second user to which digitized items are to be transferred.

In some embodiments, the token may be received at block 403 by a first device to trigger a digital transfer of the digitized items representing the remainder to be returned to the second user. In some embodiments, upon receiving the token, the first device may cause a hybrid mode platform to initiate a transfer of the digitized items in a custodial account in the quantity or value specified from a profile of the first user according to, e.g., a device ID or user ID of the first device to the profile of the second user identified by the token. As a result, asynchronous and hybrid electronic-physical interactions are enabled to complete the in-person or face-to-face activity.

Therefore, in some embodiments, upon receiving the token, the hybrid mode platform, at block 404 may update a ledger of the custodial account to transfer the assignment of the digitized items representing the remainder from the profile of the first user to the profile of the second user. In some embodiments, the ledger may include, e.g., a table, a relational data structure, a blockchain, or other suitable ledger technology.

In some embodiments, the profile of the first device may communicate the transaction to the hybrid mode platform. In some embodiments, in response, the first device may update, at block 405, the profile of the first user based on profile parameters defined in the hybrid mode platform. In some embodiments, the profile parameters may establish rules for triggering automated reloads of digitized items into the profile of the first user according to conditions. In some embodiments, the profile parameters may trigger the hybrid mode platform 101 to add a value or quantity of digitized items to the profile of the first user from a linked account (e.g., the first source account 103) based on, e.g., rules regarding the total amount of digitized items in the profile, based on a time or frequency of reloads, or any other suitable parameters.

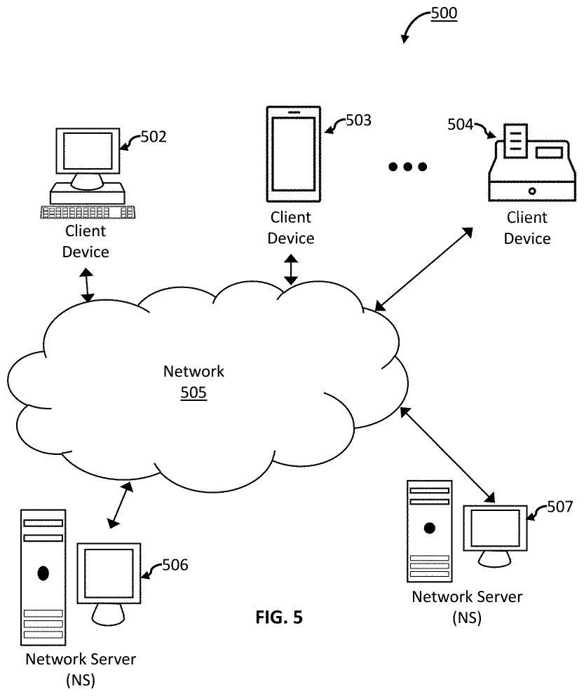

FIG. 5 depicts a block diagram of an exemplary computer-based system and platform 500 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the illustrative computing devices and the illustrative computing components of the exemplary computer-based system and platform 500 may be configured to manage a large number of members and concurrent transactions, as detailed herein. In some embodiments, the exemplary computer-based system and platform 500 may be based on a scalable computer and network architecture that incorporates various strategies for assessing the data, caching, searching, and/or database connection pooling. An example of the scalable architecture is an architecture that is capable of operating multiple servers.

In some embodiments, referring to FIG. 5, member computing device 502, member computing device 503 through member computing device 504 (e.g., clients) of the exemplary computer-based system and platform 500 may include virtually any computing device capable of receiving and sending a message over a network (e.g., cloud network), such as network 505, to and from another computing device, such as servers 506 and 507, each other, and the like. In some embodiments, the member devices 502-504 may be personal computers, multiprocessor systems, microprocessor-based or programmable consumer electronics, network PCs, and the like. In some embodiments, one or more member devices within member devices 502-504 may include computing devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member devices 502-504 may be devices that are capable of connecting using a wired or wireless communication medium such as a smartphone, a point-of-sale (POS) device, wearable computer, a laptop, tablet, desktop computer, a netbook, a video game device, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member devices within member devices 502-504 may include one or more applications, such as Internet browsers, mobile applications, voice calls, video games, videoconferencing, and email, among others. In some embodiments, one or more member devices within member devices 502-504 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 502-504 may be specifically programmed by either Java, .Net, QT, C, C++ and/or other suitable programming language. In some embodiments, one or more member devices within member devices 502-504 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 505 may provide network access, data transport and/or other services to any computing device coupled to it. In some embodiments, the exemplary network 505 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 505 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 505 may include and implement, as an alternative or in conjunction with one or more of the above, a WiMAX architecture defined by the WiMAX forum. In some embodiments and, optionally, in combination of any embodiment described above or below, the exemplary network 505 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 505 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 505 may also include mass storage, such as network attached storage (NAS), a storage area network (SAN), a content delivery network (CDN) or other forms of computer or machine readable media.

In some embodiments, the exemplary server 506 or the exemplary server 507 may be a web server (or a series of servers) running a network operating system, examples of which may include but are not limited to Microsoft Windows Server, Novell NetWare, or Linux. In some embodiments, the exemplary server 506 or the exemplary server 507 may be used for and/or provide cloud and/or network computing. Although not shown in FIG. 5, in some embodiments, the exemplary server 506 or the exemplary server 507 may have connections to external systems like email, SMS messaging, text messaging, ad content providers, etc. Any of the features of the exemplary server 506 may be also implemented in the exemplary server 507 and vice versa.

In some embodiments, one or more of the exemplary servers 506 and 507 may be specifically programmed to perform, in non-limiting example, cloud-based services (e.g., Amazon Web Services, Microsoft Azure, Google Cloud, etc.), as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 501-504. In some embodiments, the server 506 and/or the server 507 may implement one or more services, including cloud-based container services and/or container orchestration services for providing cloud-based services, such as, e.g., Kubernetes, Docker, OpenShift, among others or any combination thereof.

In some embodiments and, optionally, in combination of any embodiment described above or below, for example, one or more exemplary computing member devices 502-504, the exemplary server 506, and/or the exemplary server 507 may include a specifically programmed software module that may be configured to send, process, and receive information using a scripting language, a remote procedure call, an email, a tweet, Short Message Service (SMS), Multimedia Message Service (MMS), instant messaging (IM), internet relay chat (IRC), mIRC, Jabber, an application programming interface, Simple Object Access Protocol (SOAP) methods, Common Object Request Broker Architecture (CORBA), HTTP (Hypertext Transfer Protocol), application programming interface (API), REST (Representational State Transfer), or any combination thereof.

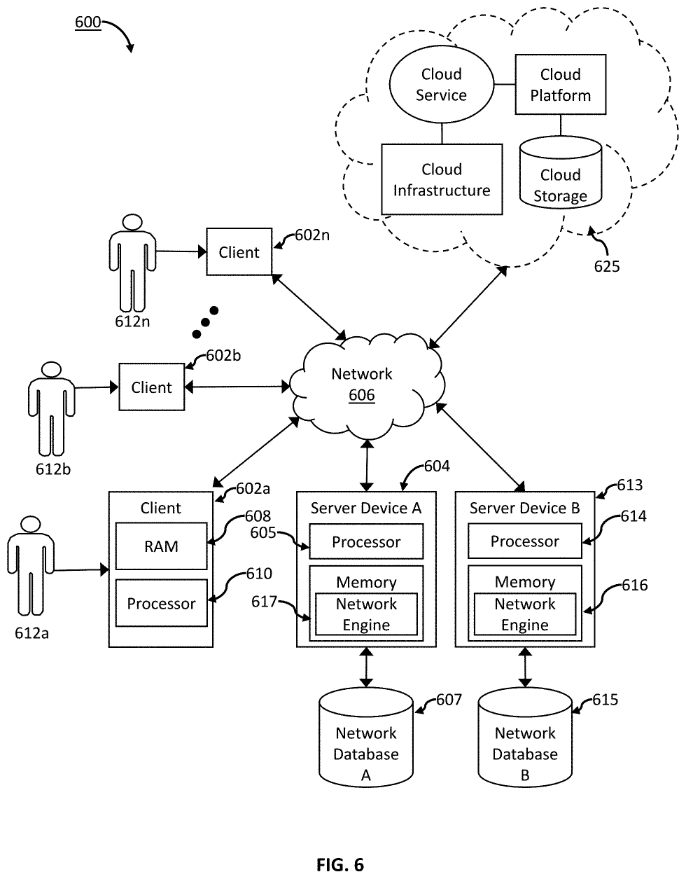

FIG. 6 depicts a block diagram of another exemplary computer-based system and platform 600 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing device 602a, member computing device 602b through member computing device 602n shown each at least includes a computer-readable medium, such as a random-access memory (RAM) 608 coupled to a processor 610 or FLASH memory. In some embodiments, the processor 610 may execute computer-executable program instructions stored in memory 608. In some embodiments, the processor 610 may include a microprocessor, an ASIC, virtual machine, software container (e.g., Docker or other suitable container), and/or a state machine among other physical and/or virtual processing technologies or any combination thereof. In some embodiments, the processor 610 may include, or may be in communication with, media, for example computer-readable media, which stores instructions that, when executed by the processor 610, may cause the processor 610 to perform one or more steps described herein. In some embodiments, examples of computer-readable media may include, but are not limited to, an electronic, optical, magnetic, or other storage or transmission device capable of providing a processor, such as the processor 610 of the member computing device 602a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 602a through 602n may also comprise a number of external or internal devices such as a mouse, a CD-ROM, DVD, a physical or virtual keyboard, a display, or other input or output devices. In some embodiments, examples of member computing devices 602a through 602n (e.g., clients) may be any type of processor-based platforms that are connected to a network 606 such as, without limitation, personal computers, digital assistants, personal digital assistants, smart phones, pagers, digital tablets, laptop computers, Internet appliances, and other processor-based devices. In some embodiments, member computing devices 602a through 602n may be specifically programmed with one or more application programs in accordance with one or more principles/methodologies detailed herein. In some embodiments, member computing devices 602a through 602n may operate on any operating system capable of supporting a browser or browser-enabled application, such as Microsoft™ Windows™, and/or Linux. In some embodiments, member computing devices 602a through 602n shown may include, for example, personal computers executing a browser application program such as Microsoft Corporation's Internet Explorer™, Google Chrome, Apple Computer, Inc.'s Safari™, Mozilla Firefox, and/or Opera. In some embodiments, through the member computing client devices 602a through 602n, user 612a, user 612b through user 612n, may communicate over the exemplary network 606 with each other and/or with other systems and/or devices coupled to the network 606. As shown in FIG. 6, exemplary server devices 604 and 613 may include processor 605 and processor 614, respectively, as well as memory 617 and memory 616, respectively. In some embodiments, the server devices 604 and 613 may be also coupled to the network 606. In some embodiments, one or more member computing devices 602a through 602n may be mobile clients.

In some embodiments, at least one database of exemplary databases 607 and 615 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL

Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

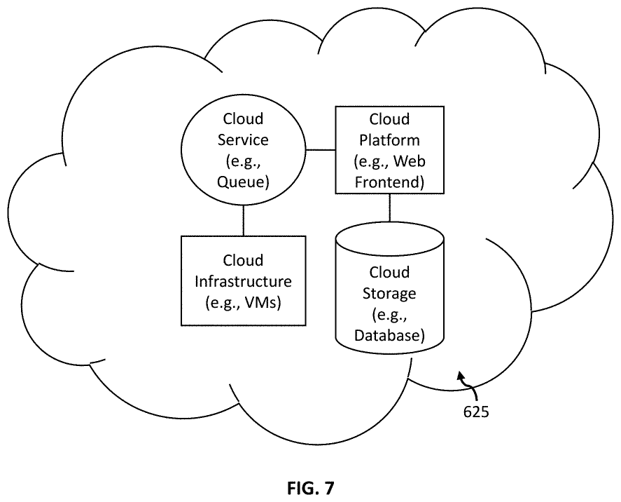

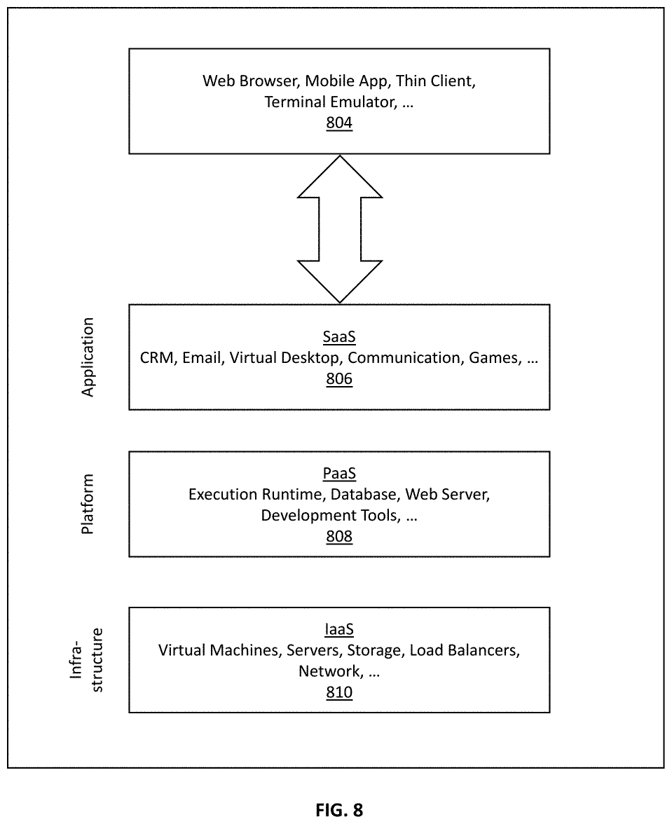

In some embodiments, the exemplary inventive computer-based systems/platforms, the exemplary inventive computer-based devices, and/or the exemplary inventive computer-based components of the present disclosure may be specifically configured to operate in a cloud computing/architecture 625 such as, but not limiting to: infrastructure a service (IaaS) 810, platform as a service (PaaS) 808, and/or software as a service (SaaS) 806 using a web browser, mobile app, thin client, terminal emulator or other endpoint 804. FIG. 7 and FIG. 8 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate.

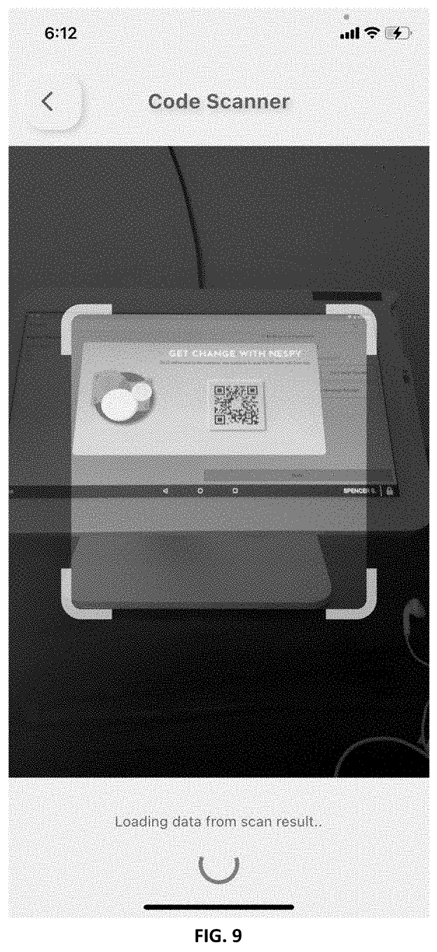

FIG. 9 depicts an example GUI of an example software application on a computing device for executing transfers of digitized items in the hybrid mode platform through the use of a token including scanning a QR code and/or barcode. In an example, the token includes encoded data communicated via any suitable optical scanning technique, such as, via a QR code or barcode. The example illustrated in FIG. 9 may be configured for the optical scanning technique, but in some embodiments, the software application may be configured for transferring a token via another communication protocol including NFC/RFID, HTTP, Bluetooth, BLE, WiFi, etc.

In some embodiment, the GUI may include a screen with a view finder such that the software application may instruct the computing device to cause a reader to receive and extract the encoded data, such as, e.g., an image sensor to capture an image of a QR code and software to extract encoded data represented by the QR code, or an RFID reader to receive a signal carrying the encoded data and software to extract the encoded data carried by the signal, or other suitable communication and extraction technique. The image, upon capture, may be represented in the viewfinder of the GUI. In some embodiments, images may be continuously captured enabling a user to position or direct the digital image sensor of the computing device towards a target such that the user may see via the viewfinder the positioning and/or direction of the digital image sensor relative to a frame depicted within the viewfinder.

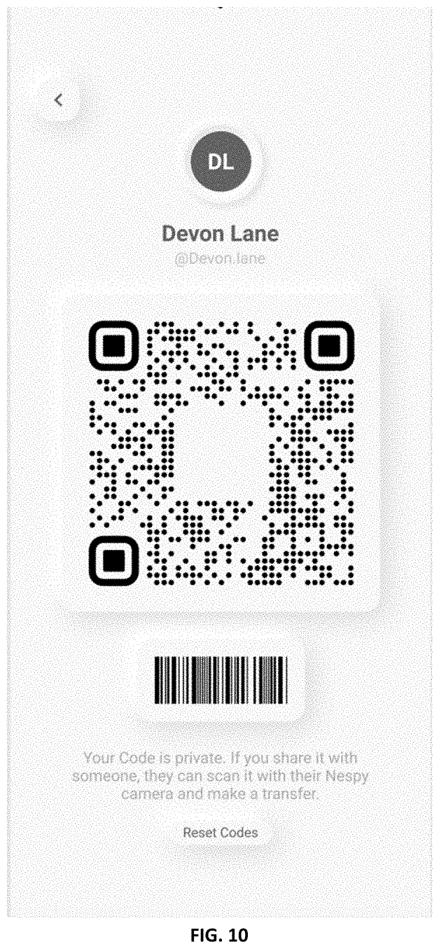

FIG. 10 depicts an example GUI of an example software application on a computing device for executing transfers of digitized items in the hybrid mode platform through the use of a token including presenting a QR code and/or barcode. In some embodiments, images may be continuously captured enabling a user to position or direct the digital image sensor of the computing device towards a target such that the user may see via the viewfinder the positioning and/or direction of the digital image sensor. Upon the target entering the viewfinder to a position within the viewfinder demarcated by a graphical element depicting a frame, the software application may automatically instruct the computing device to capture and store the image depicted in the frame. In some embodiments, the user may alternatively or additionally instruct the software application to capture and store the image depicted in the frame. For example, the user may select a graphical element that triggers the software application to perform the capture and store functionality. Accordingly, the computing device may then decode the QR code and extract the data represented therein.

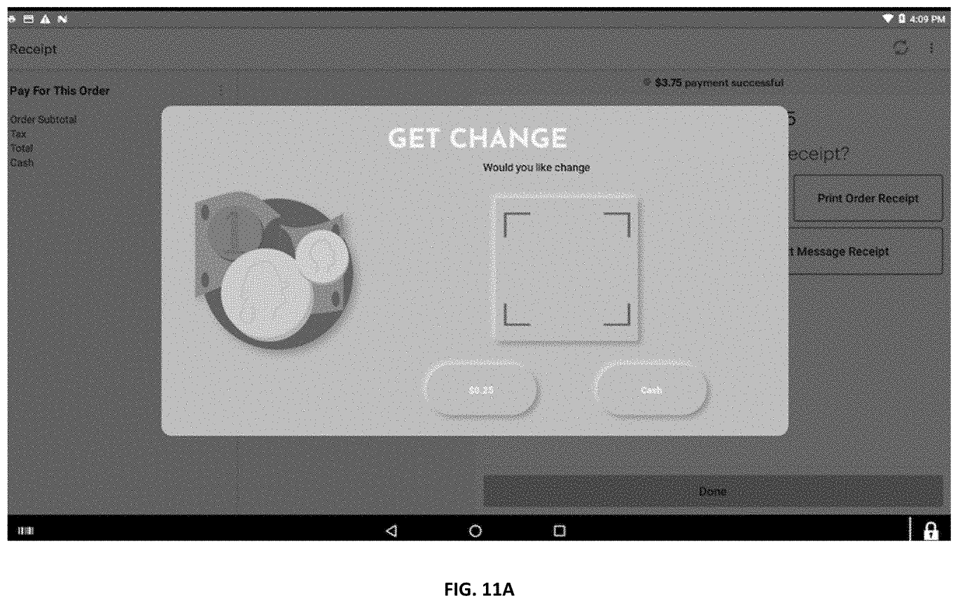

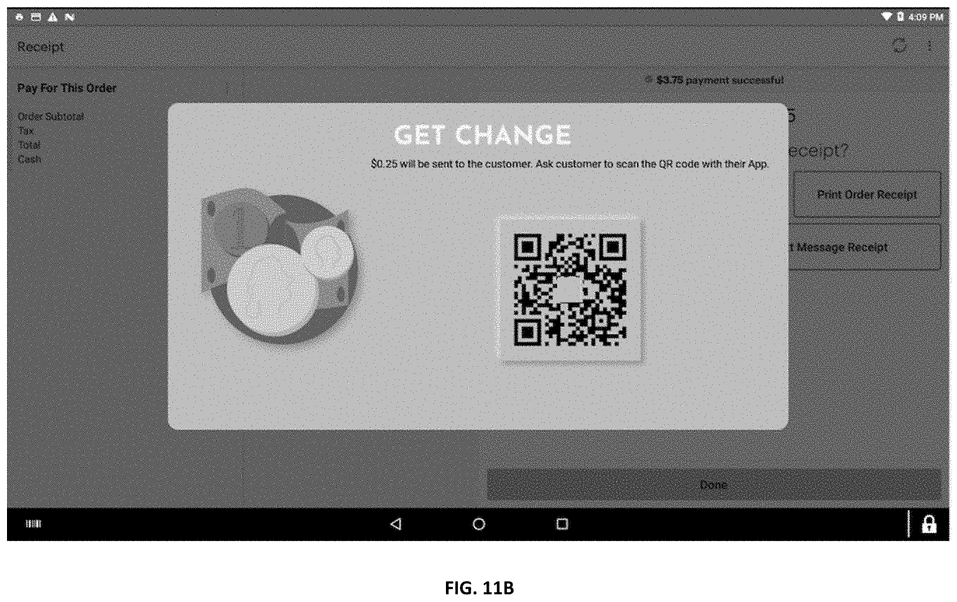

FIGS. 11A and 11B depict an example GUI of an example software application on a computing device for executing transfers of digitized items in the hybrid mode platform through the use of a token including presenting a QR code and/or barcode.

In an example of the hybrid mode platform, a point-of-sale device at a merchant location may be provided with a “digital change” option to return digitized items in exchange for excess physical items. A customer may purchase a product and pay in physical items including cash currency. The customer may pay with inexact change, such as, e.g., paying in 10 dollar bills, 20 dollar bills or any other denomination such that the payment exceeds the price of the product being purchased. Accordingly, the merchant may own a return of the excess payment. Ordinarily, the merchant would return physical “change” including coinage and/or paper money or other cash currency equating to the excess payment.

Accordingly, the merchant may select to the use the GUI for offering digital change in the to return digitized items having a quantity and/or value corresponding to all of, or a selected portion of, the excess payment. In some embodiments, the GUI may present an option screen as shown in FIG. 11A offering the excess payment (e.g., “$0.25”) as a digitized return of change or as a physical return of currency (e.g., “Cash”).

In some embodiments, where the customer selects the digitized return (e.g., the “$0.25” button), a token such as a QR code is presented as shown in FIG. 11B. In some embodiments, the customer may scan the token with a suitable software application to extract the encoded data. The encoded data may be provided to the hybrid mode platform to trigger an electronic transfer, e.g., via the ledger 107, from the merchant to the customer as described above. Thus, digital change may be returned to the customer in return for the excess physical payment.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

In some embodiments, exemplary inventive, specially programmed computing systems and platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

In some embodiments, the NFC can represent a short-range wireless communications technology in which NFC-enabled devices are “swiped,” “bumped,” “tap” or otherwise moved in close proximity to communicate. In some embodiments, the NFC could include a set of short-range wireless technologies, typically requiring a distance of 10 cm or less. In some embodiments, the NFC may operate at 13.56 MHz on ISO/IEC 18000-3 air interface and at rates ranging from 106 kbit/s to 424 kbit/s. In some embodiments, the NFC can involve an initiator and a target; the initiator actively generates an RF field that can power a passive target. In some embodiment, this can enable NFC targets to take very simple form factors such as tags, stickers, key fobs, or cards that do not require batteries. In some embodiments, the NFC's peer-to-peer communication can be conducted when a plurality of NFC-enable devices (e.g., smartphones) within close proximity of each other.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of illustrative computer-based systems or platforms of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) Linux, (2) Microsoft Windows, (3) OS X (Mac OS), (4) Solaris, (5) UNIX (6) VMWare, (7) Android, (8) Java Platforms, (9) Open Web Platform, (10) Kubernetes, (11) Docker, or other suitable computer platforms. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

In some embodiments, illustrative computer-based systems or platforms of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, the term “device”, “computing device”, “mobile device”, “mobile electronic device,” or the like, may refer to any stationary or portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RCS, CAST and Skipjack), cryptographic hash algorithms (e.g., MD5, RIPEMD-160, RTRO, SHA-1, SHA-2, Tiger (TTH), WHIRLPOOL, RNGs).

As used herein, the term “user” shall have a meaning of at least one user. In some embodiments, the terms “user”, “subscriber” “consumer” or “customer” should be understood to refer to a user of an application or applications as described herein, and/or a consumer of data supplied by a data provider. By way of example, and not limitation, the terms “user” or “subscriber” can refer to a person who receives data provided by the data or service provider over the Internet in a browser session or can refer to an automated software application which receives the data and stores or processes the data.

The aforementioned examples are, of course, illustrative and not restrictive.

At least some aspects of the present disclosure will now be described with reference to the following numbered clauses.

1. A method, comprising:

receiving, from a first device by at least one processor of a platform, an electronic record recording at least one specified value and at least one physical item having at least one item value;

determining, by the at least one processor, a difference between the at least one specified value and the at least one item value;

identifying, by the at least one processor, a first profile associated with the first device;

generating, by the at least one processor, a token representing the first profile and at least one digitized item associated with the difference;

transmitting, by the at least one processor, the token to the first device;

receiving, by the at least one processor, the token from a second device;

determining, by the at least one processor, a second profile associated with the second device; and

transferring, by the at least one processor, the at least one digitized item from the first profile to the second profile based at least in part on the token.

2. A system, comprising:

at least one processor of a platform, wherein the at least one processor is configured to execute software instruction stored in a non-transitory computer readable medium that cause the platform to perform steps to:
receive, from a first device, an electronic record recording at least one specified value and at least one physical item having at least one item value;
determine a difference between the at least one specified value and the at least one item value;
identify a first profile associated with the first device;
generate a token representing the first profile and at least one digitized item associated with the difference;
transmit the token to the first device;
receive the token from a second device;
determine a second profile associated with the second device; and
transfer the at least one digitized item from the first profile to the second profile based at least in part on the token.
   3. A non-transitory computer readable medium having software instructions stored thereon, the software instructions configured to cause at least one processor to perform steps comprising:

receiving, from a first device, an electronic record recording at least one specified value and at least one physical item having at least one item value;

determining a difference between the at least one specified value and the at least one item value;

identifying a first profile associated with the first device;

generating a token representing the first profile and at least one digitized item associated with the difference;

transmitting the token to the first device;

receiving the token from a second device;

determining a second profile associated with the second device; and

transferring the at least one digitized item from the first profile to the second profile based at least in part on the token.

While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added, and/or any desired steps may be eliminated).

What is claimed is:

1. A method, comprising:
receiving, by at least one processor, a token from a second device;
wherein the token comprises encoded data comprising:
a first profile identifier that identifies a first profile associated with a first device, and
at least one digitized item identifier identifying at least digitized item in at least one difference quantity associated with at least one physical exchange;
wherein the at least one difference quantity comprises a difference between:
at least one specified value for the physical exchange and
at least one item value of at least one physical item provided for the physical exchange;
determining, by the at least one processor, a second profile associated with the second device;
extracting, by the at least one processor, the encoded data of the token to identify the first profile and the at least one digitized item based on the first profile identifier and the at least one digitized item;
transferring, by the at least one processor via a ledger, the at least one digitized item from the first profile to the second profile based at least in part on the token; and
instructing, by the at least one processor, the first device to authorize the physical exchange based at least in part on the at least one item value and the transfer of the at least one digitized item equating to the at least one specified value.

2. The method as recited in claim 1, wherein the token comprises at least one of:
a Quick Response (QR) code,
a barcode,
a Radio Frequency Identification (RFID) signal,
a Near Field Communication (NFC) signal, or
a Bluetooth signal.

3. The method as recited in claim 1, wherein the first device comprises a Point-of-Sale device, the at least one specified value is a monetary amount, and the at least one item value is a quantity of physical currency.

4. The method as recited in claim 3, further comprising:
generating, by the at least one processor, the at least one digitized item based at least in part on the at least one difference quantity;
wherein the at least on digitized item comprises a non-currency item redeemable for a value based at least in part on the at least one difference quantity; and
transmitting, by the at least one processor, the at least one digitized item to the second device, wherein the at least one digitized item is configured to be communicated to the first device to enable a redemption for the value associated with the at least one difference quantity.

5. The method as recited in claim 1, further comprising:
instructing, by the at least one processor, the first device to print a physical receipt representing the physical exchange;
wherein the first device is configured to print on the physical receipt:
the at least one specified value for the physical exchange and the token;
wherein the token comprises a machine readable indicia configured to be read via an imaging device of the second device to transfer the encoded data.

6. The method as recited in claim 1, further comprising:
receiving, from the first device by the at least one processor, an electronic record recording the at least one specified value and the at least one physical item having the at least one item value;
determining, by the at least one processor, the difference between the at least one specified value and the at least one item value;
identifying, by the at least one processor, the first profile associated with the first device;
generating, by the at least one processor, the token based on the first profile and the at least one digitized item associated with the difference; and
instructing, by the at least one processor, the first device to present the token for communication to the second device.

7. The method as recited in claim 1, further comprising:
determining, by the at least one processor, a first profile balance associated with the first profile being less than the at least one difference quantity;
determining, by the at least one processor, a linked source account associated with the first profile;
determining, by the at least one processor, at least one balance reload rule associated with the first profile;
generating, by the at least one processor, at least one balance reload request to the linked source account based at least in part on the at least one balance reload rule; and
transferring, by the at least one processor via the ledger, the at least one digitized item from the first profile to the second profile upon reloading the first profile balance by the linked source account.

8. The method as recited in claim 1, further comprising:
transferring, by the at least one processor via the ledger, the at least one digitized item from the first profile to the second profile;
determining, by the at least one processor, a first profile balance associated with the first profile being negative as a result of transferring the at least one digitized item;
determining, by the at least one processor, a linked source account associated with the first profile;
determining, by the at least one processor, at least one balance reload rule associated with the first profile; and
generating, by the at least one processor, at least one balance reload request to the linked source account based at least in part on the at least one balance reload rule and the first profile balance being negative.

9. A system, comprising:
at least one processor of a platform, wherein the at least one processor is configured to execute software instructions stored in a non-transitory computer readable medium that are configured to, upon execution, cause the at least one processor to perform steps to:
receive a token from a second device;
wherein the token comprises encoded data comprising:
a first profile identifier that identifies a first profile associated with a first device, and
at least one digitized item identifier identifying at least digitized item in at least one difference quantity associated with at least one physical exchange;
wherein the at least one difference quantity comprises a difference between:
at least one specified value for the physical exchange and
at least one item value of at least one physical item provided for the physical exchange;
determine second profile associated with the second device;
extract the encoded data of the token to identify the first profile and the at least one digitized item based on the first profile identifier and the at least one digitized item;
transfer, via a ledger, the at least one digitized item from the first profile to the second profile based at least in part on the token; and
instruct the first device to authorize the physical exchange based at least in part on the at least one item value and the transfer of the at least one digitized item equating to the at least one specified value.

10. The system as recited in claim 9, wherein the software instructions are further configured to, upon execution, cause the at least one processor to perform steps to:
instruct the first device to print a physical receipt representing the physical exchange;
wherein the first device is configured to print on the physical receipt:
the at least one specified value for the physical exchange and
the token;
wherein the token comprises a machine readable indicia configured to be read via an imaging device of the second device to transfer the encoded data.

11. The system as recited in claim 9, wherein the first device comprises a Point-of-Sale device, the at least one specified value is a monetary amount, and the at least one item value is a quantity of physical currency.

12. The system as recited in claim 11, wherein the software instructions are further configured to, upon execution, cause the at least one processor to perform steps to:
generate the at least one digitized item based at least in part on the at least one difference quantity;
wherein the at least on digitized item comprises a non-currency item redeemable for a value based at least in part on the at least one difference quantity; and
transmit the at least one digitized item to the second device, wherein the at least one digitized item is configured to be communicated to the first device to enable a redemption for the value associated with the at least one difference quantity.

13. The system as recited in claim 9, wherein the software instructions are further configured to, upon execution, cause the at least one processor to perform steps to:
receive, from the first device, an electronic record recording the at least one specified value and the at least one physical item having the at least one item value;
determine the difference between the at least one specified value and the at least one item value;
identify the first profile associated with the first device;
generate the token based on the first profile and the at least one digitized item associated with the difference; and
instruct the first device to present the token for communication to the second device.

14. The system as recited in claim 9, wherein the software instructions are further configured to, upon execution, cause the at least one processor to perform steps to:
determine a first profile balance associated with the first profile being less than the at least one difference quantity;
determine linked source account associated with the first profile;
determine at least one balance reload rule associated with the first profile;
generate at least one balance reload request to the linked source account based at least in part on the at least one balance reload rule; and
transfer, via the ledger, the at least one digitized item from the first profile to the second profile upon reloading the first profile balance by the linked source account.

15. The system as recited in claim 14, wherein the software instructions are further configured to, upon execution, cause the at least one processor to perform steps to:
transfer, via the ledger, the at least one digitized item from the first profile to the second profile;
determine a first profile balance associated with the first profile being negative as a result of transferring the at least one digitized item;
determine a linked source account associated with the first profile;
determine at least one balance reload rule associated with the first profile; and
generate at least one balance reload request to the linked source account based at least in part on the at least one balance reload rule and the first profile balance being negative.

16. A non-transitory computer readable medium having software instructions stored thereon, the software instructions configured to cause at least one processor to perform steps comprising:
receiving a token from a second device;
wherein the token comprises encoded data comprising:
a first profile identifier that identifies a first profile associated with a first device, and
at least one digitized item identifier identifying at least digitized item in at least one difference quantity associated with at least one physical exchange;
wherein the at least one difference quantity comprises a difference between:
at least one specified value for the physical exchange and
at least one item value of at least one physical item provided for the physical exchange;
determining second profile associated with the second device;
extracting the encoded data of the token to identify the first profile and the at least one digitized item based on the first profile identifier and the at least one digitized item;
transferring, via a ledger, the at least one digitized item from the first profile to the second profile based at least in part on the token; and
instructing the first device to authorize the physical exchange based at least in part on the at least one item value and the transfer of the at least one digitized item equating to the at least one specified value.

17. The non-transitory computer readable medium as recited in claim 16, further comprising software instructions that are configured to cause the at least one processor to perform steps further comprising:
instructing the first device to print a physical receipt representing the physical exchange;
wherein the first device is configured to print on the physical receipt:
the at least one specified value for the physical exchange and
the token;
wherein the token comprises a machine readable indicia configured to be read via an imaging device of the second device to transfer the encoded data.

18. The non-transitory computer readable medium as recited in claim 16, further comprising software instructions that are configured to cause the at least one processor to perform steps further comprising:
generating the at least one digitized item based at least in part on the at least one difference quantity;
wherein the at least on digitized item comprises a non-currency item redeemable for a value based at least in part on the at least one difference quantity; and
transmitting the at least one digitized item to the second device, wherein the at least one digitized item is configured to be communicated to the first device to enable a redemption for the value associated with the at least one difference quantity.

19. The non-transitory computer readable medium as recited in claim 16, further comprising software instructions that are configured to cause the at least one processor to perform steps further comprising:
transferring, via the ledger, the at least one digitized item from the first profile to the second profile;
determining a first profile balance associated with the first profile being negative as a result of transferring the at least one digitized item;
determining a linked source account associated with the first profile;
determining at least one balance reload rule associated with the first profile; and
generating at least one balance reload request to the linked source account based at least in part on the at least one balance reload rule and the first profile balance being negative.

20. The non-transitory computer readable medium as recited in claim 16, further comprising software instructions that are configured to cause the at least one processor to perform steps further comprising:
determining a first profile balance associated with the first profile being less than the at least one difference quantity;
determining a linked source account associated with the first profile;
determining at least one balance reload rule associated with the first profile;
generating at least one balance reload request to the linked source account based at least in part on the at least one balance reload rule; and
transferring, via the ledger, the at least one digitized item from the first profile to the second profile upon reloading the first profile balance by the linked source account.
